(19) United States
(12) Patent Application Publication
(10) Pub. No.: US 2023/0066956 A1
(43) Pub. Date: Mar. 2, 2023

(54) METHOD AND SYSTEM FOR DATA-BUDGET CONSTRAINED NETWORK RESOURCE-EFFICIENT VIDEO STREAMING

(71) Applicants: AT&T Intellectual Property I, L.P., Atlanta, GA (US); University of Connecticut, Farmington, CT (US)

(72) Inventors: Subhabrata Sen, Westfield, NJ (US); Bing Wang, Storrs Mansfield, CT (US); Yanyuan Qin, Mansfield, CT (US)

(73) Assignees: AT&T Intellectual Property I, L.P., Atlanta, GA (US); University of Connecticut, Farmington, CT (US)

(21) Appl. No.: 17/463,710

(22) Filed: Sep. 1, 2021

(51) Int. Cl. H04N 21/845; H04N 21/854; H04N 21/414; H04N 21/2662

(52) U.S. Cl. CPC H04N 21/8456; H04N 21/85406; H04N 21/41407; H04N 21/2662

(57) ABSTRACT

Aspects of the subject disclosure may include, for example, a method in which a data-budget aware video streaming rate adaptation system receives information including a total data budget and a target quality level for a video streaming session presenting a video program; the video program has a plurality of tracks each encoding video content and including video content segments for successive presentation. The method also includes determining a target track for each of the video content segments; providing to a video streaming system the target track for a next successive video content segment; calculating a remaining data budget based on the total data budget and current data usage; and dynamically adjusting, in accordance with the remaining data budget, the target track for each remaining video content segment. Other embodiments are disclosed.

### FIELD OF THE DISCLOSURE

The subject disclosure relates to streaming video over cellular phone networks, and more particularly to a method and system for resource-efficient video streaming on a constrained data budget.

### BACKGROUND

Over-the-top (OTT) mobile video streaming is extremely popular, already accounting for the bulk of traffic on cellular networks. However, video streaming is bandwidth intensive and places a heavy demand on users' limited monthly cellular data budgets. It is also important that a streaming video session deliver good quality of experience (QoE) to the user. This can be challenging to achieve, especially when streaming over cellular networks, given both the relatively high bandwidth requirements of streaming video and the highly dynamic cellular network conditions which can exhibit high network bandwidth variability.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 for performing adaptive bit rate (ABR) streaming, in accordance with various aspects described herein.

FIG. 2B schematically illustrates a system for data budget constrained ABR streaming, in accordance with embodiments of the disclosure.

FIG. 2C shows a chart depicting a tradeoff between perceived streaming video quality and video bitrate in the system of FIG. 2B.

FIG. 2D schematically illustrates a system for dynamically tracking and planning data usage in a video streaming session, in accordance with embodiments of the disclosure.

FIG. 2E schematically illustrates an approach to determining a per-session data budget based on a data budget ladder, in accordance with embodiments of the disclosure.

FIG. 2F is a flowchart depicting an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a data-budget aware video streaming rate adaptation system using a per-session data budget and dynamically adjusting a target track for each remaining segment of a streaming video program. Other embodiments are described in the subject disclosure.

One or more aspects of the subject disclosure include a method that includes receiving, by a processing system including a processor, information comprising a total data budget and a target quality level for a video streaming session in which a video program comprising video content is to be presented; the video program has a plurality of tracks each encoding the video content, with each track comprising a plurality of video content segments for successive presentation. The method also includes determining a mapping of the plurality of tracks to a plurality of quality levels for the video content, and a data budget ladder for the video streaming session based on the mapping and the total data budget. The method further includes determining, in accordance with the data budget ladder, a target track for each of the plurality of video content segments. The method also includes providing, to a video streaming system, the target track for a next successive video content segment; the video streaming system selects a track for the video content segment based at least in part on the target track. The method further includes estimating a current data usage for the video streaming session; calculating a remaining data budget based on the total data budget and the current data usage; and adjusting, in accordance with the remaining data budget, the target track for each remaining video content segment of the plurality of video content segments.

One or more aspects of the subject disclosure include a device that comprises a processing system and a memory that stores instructions; the instructions when executed by the processing system, facilitate performance of operations. The operations include receiving information comprising a total data budget and a target quality level for a video streaming session in which a video program comprising video content is to be presented; the video program has a plurality of tracks each encoding the video content, with each track comprising a plurality of video content segments for successive presentation. The operations also include determining a mapping of the plurality of tracks to a plurality of quality levels for the video content, and a data budget ladder for the video streaming session based on the mapping and the total data budget. The operations further include determining, in accordance with the data budget ladder, a target track for each of the plurality of video content segments. The operations also include providing, to an adaptive bit rate (ABR) video streaming system, the target track for a next successive video content segment; the video streaming system selects a track for the video content segment based at least in part on the target track. The operations further include estimating a current data usage for the video streaming session; calculating a remaining data budget based on the total data budget and the current data usage; and adjusting, in accordance with the remaining data budget, the target track for each remaining video content segment of the plurality of video content segments.

One or more aspects of the subject disclosure include a non-transitory machine readable medium comprising instructions that, when executed by a processing system including a processor, facilitate performance of operations. The operations include receiving, via a user interface of a user equipment (UE) device, information comprising a total data budget and a target quality level for a video streaming session in which a video program comprising video content is to be presented; the video program has a plurality of tracks each encoding the video content, with each track comprising a plurality of video content segments for successive presentation. The operations also include determining a mapping of the plurality of tracks to a plurality of quality levels for the video content, and a data budget ladder for the video streaming session based on the mapping and the total data budget. The operations further include determining, in accordance with the data budget ladder, a target track for each of the plurality of video content segments. The operations also include providing, to a video streaming system, the target track for a next successive video content segment; the video streaming system selects a track for the video content segment based at least in part on the target track. The operations further include estimating a current data usage for the video streaming session; calculating a remaining data budget based on the total data budget and the current data usage; and adjusting, in accordance with the remaining data budget, the target track for each remaining video content segment of the plurality of video content segments.

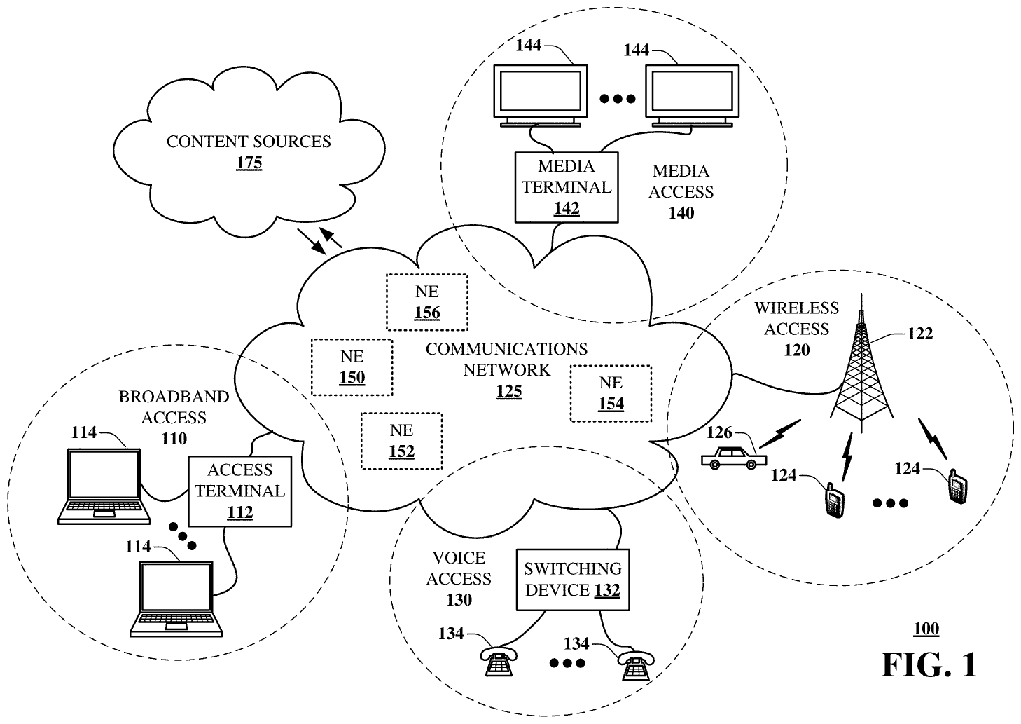

Referring now to FIG. 1, a block diagram is shown illustrating an example, non-limiting embodiment of a system 100 in accordance with various aspects described herein. For example, system 100 can facilitate in whole or in part receiving information including a total data budget and a target quality level for a video streaming session in which a video program has a plurality of tracks each encoding video content and including a plurality of video content segments for successive presentation; determining a target track for each of the video content segments; providing to a video streaming system the target track for a next successive video content segment; calculating a remaining data budget based on the total data budget and current data usage; and adjusting, in accordance with the remaining data budget, the target track for each remaining video content segment. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

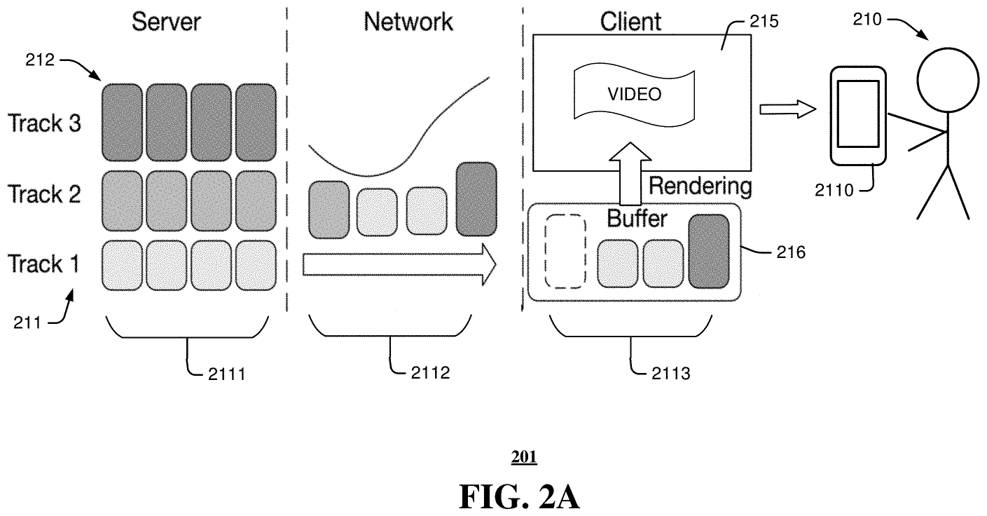

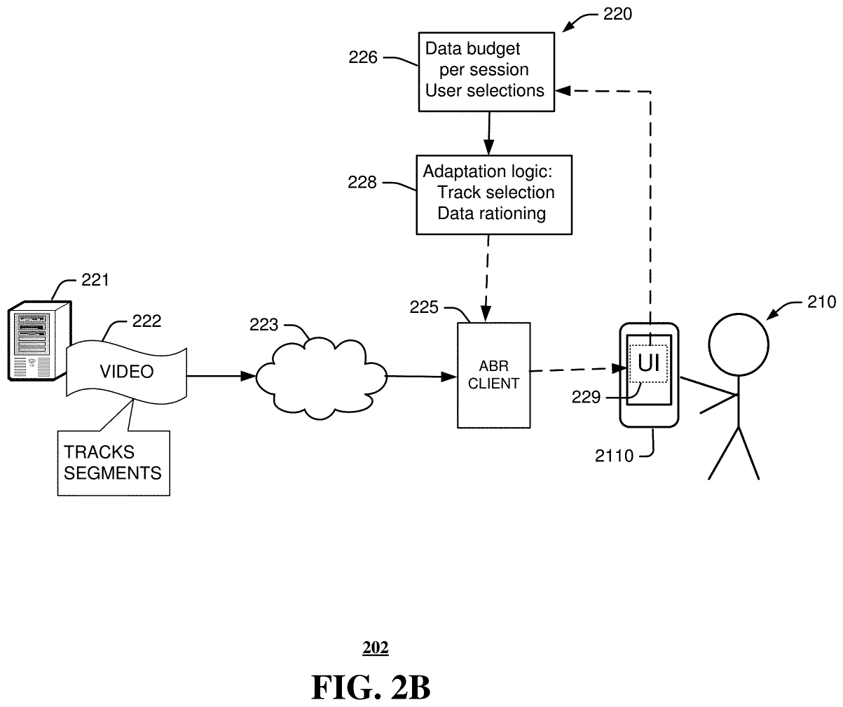

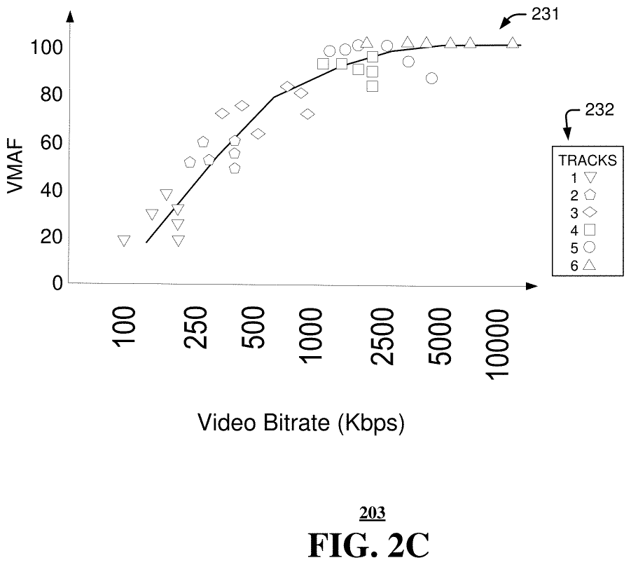

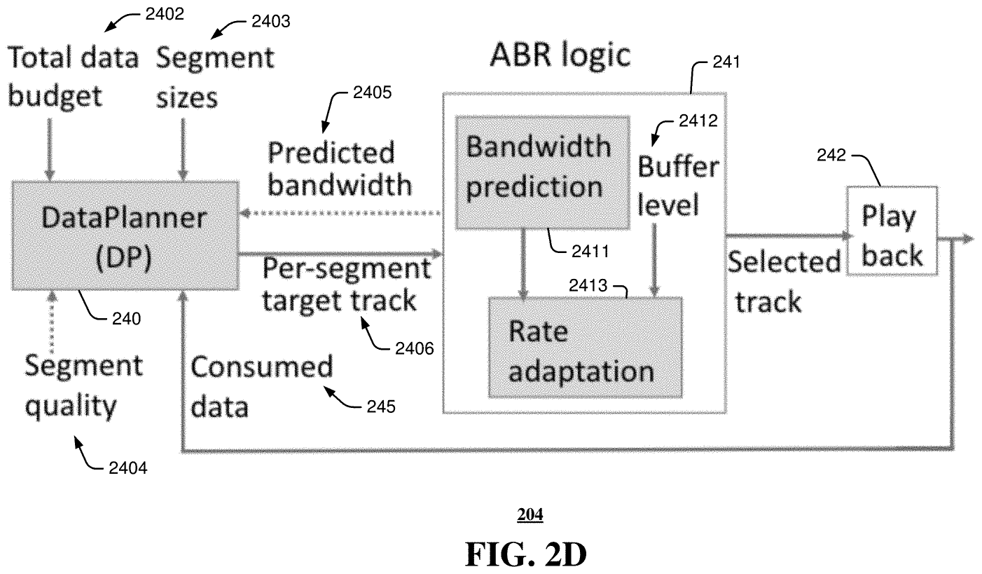

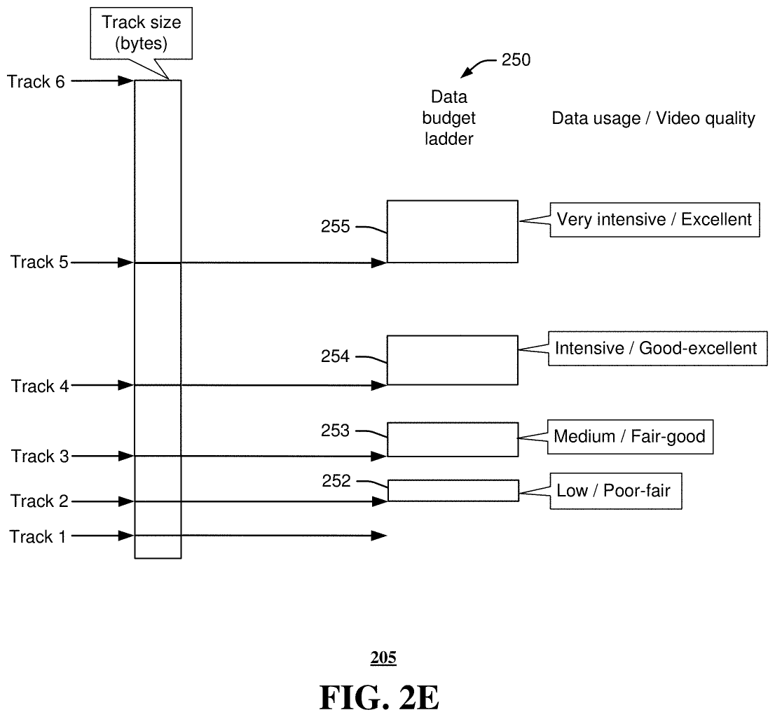

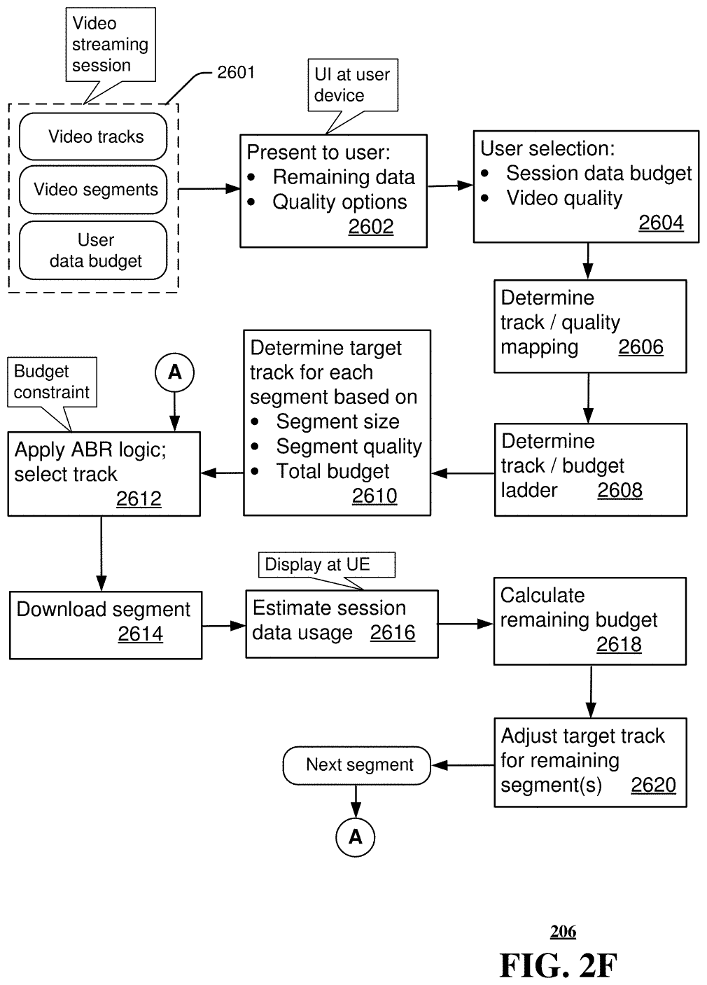

FIG. 2A is a block diagram 201 illustrating an example, non-limiting embodiment of adaptive bit rate (ABR) video streaming via the communication network of FIG. 1, in accordance with various aspects described herein. For each video in ABR streaming, a server 2111 encodes the content into multiple independent tracks 211; the tracks include the same content but differ in frame rate, encoding bitrate, resolution, and/or perceptual quality. Each track is further divided into a series of segments 212; each segment contains data for about 2-10 seconds of playback time. For each segment position in the video, the encoding bitrates and hence the perceptual quality increase from lower to higher tracks. This scheme is sometimes referred to as a track ladder, with progressively higher “rungs” corresponding to tracks having higher video quality and thus requiring greater data usage.

During streaming playback, segments from different tracks are delivered over network 2112 to ABR client 2113. The ABR client can then use an adaptation logic to dynamically determine which quality variant (i.e., from which track) to fetch for each segment position in the video. The video segments are stored in a buffer 213 and then rendered as video content 215 for display at equipment (e.g. a smartphone 2110) of a user 210. In order to limit data usage, according to some aspects a video service providing the content also provides the user with options via a user interface (UI); the user can select a video option with lower data usage (and typically a lower quality experience). The selected option can then be mapped to a specific track in the track ladder, so that ABR track selection is constrained to that track or a lower track; in addition, a network operator can cap the maximum network bandwidth available in a video session to a fixed value.

FIG. 2B schematically illustrates a system 202 for data budget constrained ABR streaming, in accordance with embodiments of the disclosure. In an embodiment, video content 222 provided by server 221 has multiple tracks, with each track divided into a series of segments. For each segment position in the video, a segment from a selected track is fetched via network 223 by the ABR client 225. In this embodiment, a data-budget aware ABR scheme 220 executes at the ABR client, including determining 226 a per-session data budget based on selections made by the user 210 via UI 229, and applying 228 the adaptation logic to select suitable tracks for delivering good QoE, while planning and rationing data usage during the video session.

The per-session data budget permits the user to explicitly control the amount of data consumed in the video streaming session. In particular, the user can make an informed decision regarding the amount of data they are willing to spend for the current session, while taking into account factors such as their remaining cellular data budget for the month.

FIG. 2C shows a chart 203 depicting a tradeoff between perceived streaming video quality and video bitrate in the system of FIG. 2B. The plot 231 shows perceptual quality of a VBR animation video (encoded according to the H.264 standard), as measured by the Video Multifunction Assessment Fusion (VMAF) model, as a function of video encoding bitrate; the video has six tracks, as shown by the different symbols 232 in FIG. 2C, with each symbol corresponding to a segment. The highest tracks (tracks 5 and 6) have only slightly higher VMAF values than track 4, at the cost of a significantly higher bitrate. A data-budget aware ABR scheme thus has an incentive to select track 4 over track 5 or track 6, to obtain good QoE with significantly lower data usage. It is understood that VMAF is only an example of a perceptual video quality metric; a similar tradeoff between video quality and bitrate is observed when another metric is used.

According to embodiments of the disclosure, the user selects a per-session data budget so that the ABR client has an explicit control on session data usage, as opposed to selecting a target perceptual quality level so that the ABR client attempts to deliver content at that quality level.

FIG. 2D schematically illustrates a system 204 for dynamically tracking and planning data usage in a video streaming session, in accordance with embodiments of the disclosure. System 204 can monitor data usage and the remaining data budget during a video session (that is, while tracks are being selected and segments are being downloaded and rendered), and revisit and adapt plans for spending the session data budget accordingly.

As shown in FIG. 2D, the system includes a DataPlanner (DP) component 240, which interacts with the ABR logic components 241 at a client (e.g. client 226 in FIG. 2B). In this embodiment, inputs to DP 240 include the total data budget 2402, the segment sizes 2403 of the video segments, a measure of segment quality 2404 for the video segments, a predicted network bandwidth 2405 provided by a bandwidth prediction component 2411 of the ABR logic, and the amount of data 245 already consumed by the playback function 242 of the system (i.e. video data presented to the user). For each segment, the DP selection 2406 of a target track is provided to the ABR logic 241. The ABR logic includes a rate adaptation component 2413; inputs to the rate adaptation component include the predicted bandwidth and a buffer level 2412.

In an embodiment, at the beginning of a streaming session, DP determines a target track for each segment, based on the total data budget and per-segment size (and also per-segment quality if that information is available). The target track Lᵢ for segment i represents an upper bound on the rung in the ABR track ladder for that segment, which is then used in conjunction with the ABR logic to ensure that the selected track for segment i does not exceed Lᵢ to satisfy the data budget constraint. Subsequently, each time it runs, DP calculates the remaining data budget as the total data budget subtracted by the amount of data 245 that has already been consumed, and dynamically adjusts the target track for each remaining segment position.

It will be appreciated that this approach differs from a simple track-capping strategy (i.e., restricting selection of tracks with high data usage for all segments) in that (i) the target track for each segment is determined individually, and hence the target tracks for two segments can differ from each other, (ii) at any instant, the planning approach conducts its per-segment target track selection decision by globally considering the sizes, complexities and/or quality (if available) of all the remaining video segments and the remaining data budget for the session, and (iii) the planning process is run periodically, revisiting and changing earlier decisions when appropriate, and so can better account for changing network dynamics and remaining data budgets. This combination of time-dynamic planning and fine-grained target track selection permits a better balance between data budget and quality than a static track-capping strategy.

In some embodiments, the core ABR logic 241 runs after each segment is downloaded to determine the track for the next segment, while DP runs less frequently; for example, (i) at a predetermined time interval A, or (ii) after a predetermined number N of segments have been downloaded. In both instances, there can be a tradeoff; a low value of A or N can lead to greater overhead (more data usage than needed for good QoE), while a high value can lead to slow reaction to the remaining data budget.

In various embodiments, track capping can be combined with data budget based planning to influence the behavior of the ABR logic. This can be done in two ways: (i) cap-beforehand, where the set of tracks to be selected is restricted (e.g., by specifying a per-segment cap directly to the ABR logic); or (ii) cap-afterward, where the output of DP can be applied after the track selection of the ABR logic. In these embodiments, DP can treat the ABR logic as a black box, and interacts with the ABR logic through well-defined application program interfaces (APIs); this permits DP to be easily retrofitted into an existing ABR system.

In additional embodiments, the ABR logic 241 may take account of the predicted network bandwidth 2405 during rate adaptation. The DP component 240 can then access the predicted bandwidth through an API, and thus consider the joint constraint of data budget and predicted network bandwidth.

In general, the session data budget can be determined by a policy mechanism. This can be realized by providing the user a user interface as shown schematically in FIG. 2B; the user can select from multiple choices, e.g., high, medium, or low data usage, each mapped to an appropriate per-session data budget for a particular video. In various embodiments, the mapping of the choices to the data budget values takes into account specific characteristics of a video; for example, the genre of the video, which influences its content complexity. In addition, the encoding codecs and ABR track ladder designs used to create the ABR tracks for the video can lead to significantly different encoding bitrates for each track. As an illustration, if it is desired to watch a 10-minute video with a total data budget of 75 MB (which corresponds to an average bitrate of 1 Mbps), that budget can be very limiting for certain videos (e.g., those including sports, action sequences etc.), while not being a significant constraint for other videos (e.g., those including talking heads, animation, etc.). A single data budget will not, in general, be applicable to diverse video genres and encoding ABR track ladders.

FIG. 2E schematically illustrates 205 an approach to determining a per-session data budget based on a data budget ladder, in accordance with embodiments of the disclosure. This approach first roughly maps tracks to video content quality levels, e.g., track 1 maps to very poor quality, track 2 to poor quality, track 3 to fair quality, etc.

Data budget ladder 250 is determined by using dynamic data planning strategies to guide the ABR rate adaptation. In an embodiment, the data budget ladder 250 for a particular video is determined as follows: The lowest rung 252 in the data budget ladder (e.g., low data usage, poor-fair quality) maps to data usage between track 2 and 3, i.e., the data budget is set to D=r_{d}×S₂, where D is the total data budget for the session, r_{d}≥1 and S₂ is the size of track 2. Similarly, the second lowest rung 253 in the data budget ladder (e.g., medium data usage, fair-good quality) maps to data usage between track 3 and track 4 with the data budget set to D=r_{d}×S₃, where r_{d}≥1 and S₃ is the size of track 3. The other rungs 254, 255 in the data budget ladder are defined in similar ways. The parameter r_{d} permits a finer-level decision of data budgets within the rung (e.g., based on the remaining monthly data plan, the content of the video, etc.). A larger r_{d} results in better performance/QoE at the cost of higher data usage.

FIG. 2F is a flowchart depicting an illustrative embodiment of a method 206 in accordance with various aspects described herein. A video to be viewed in a streaming session 2601 is organized into tracks and segments; the streaming session is subject to the user's data budget (e.g., a monthly cellular data budget). In this embodiment, a data budget constrained ABR system (DCS) presents a user with a user interface (step 2602) at the user's equipment (e.g., smartphone); the UI shows the remaining cellular data budget for the month, and offers options for selecting a desired QoE.

In step 2604, the system receives user input via the UI: the total session data budget (the upper bound on data usage for the video streaming session), and the selected quality level. The system maps the video tracks to quality levels (step 2606) and determines a data budget ladder for the video (step 2608).

For each video segment, the system determines a target track (step 2610). In this embodiment, the target track is based on the size of the segment, the segment quality, and the total data budget for the session. The ABR logic selects the track for the segment (step 2612). The segment is then downloaded (step 2614).

During the streaming session, the system estimates the data usage for the video segments already viewed (step 2616), and calculates the remaining data budget (step 2618). In this embodiment, these results are displayed at the user equipment (UE).

Based on the remaining session data budget, the system dynamically adjusts the target track for each remaining segment (step 2020). The method continues with ABR selection of the next segment.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

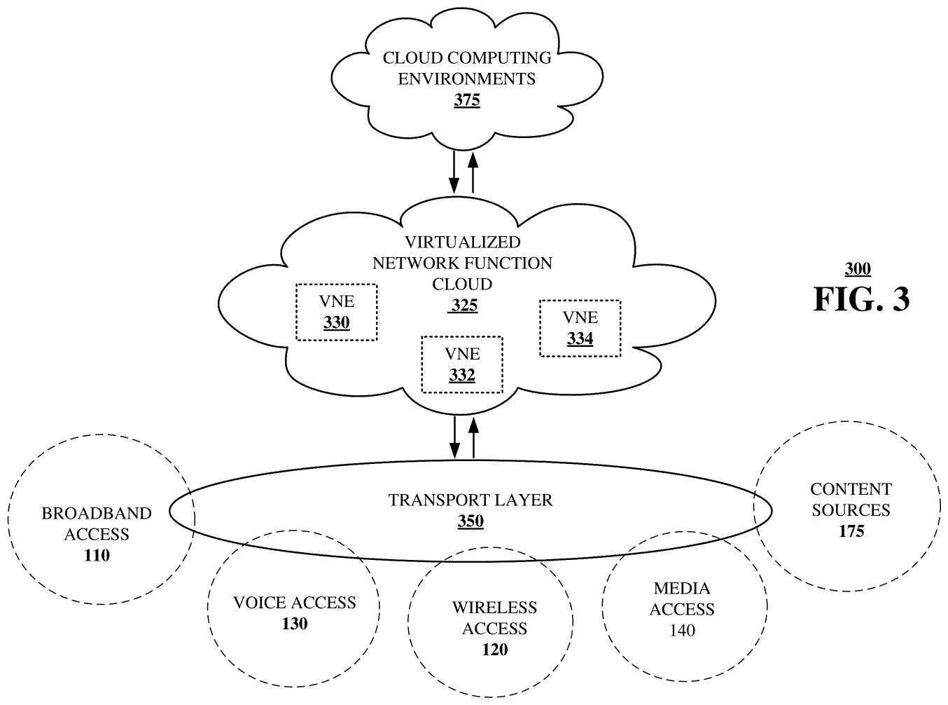

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of systems 202-204, and method 206 presented in FIGS. 1, 2B, 2D-2F and 3. For example, virtualized communication network 300 can facilitate in whole or in part receiving information including a total data budget and a target quality level for a video streaming session in which a video program has a plurality of tracks each encoding video content and including a plurality of video content segments for successive presentation; determining a target track for each of the video content segments; providing to a video streaming system the target track for a next successive video content segment; calculating a remaining data budget based on the total data budget and current data usage; and adjusting, in accordance with the remaining data budget, the target track for each remaining video content segment.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

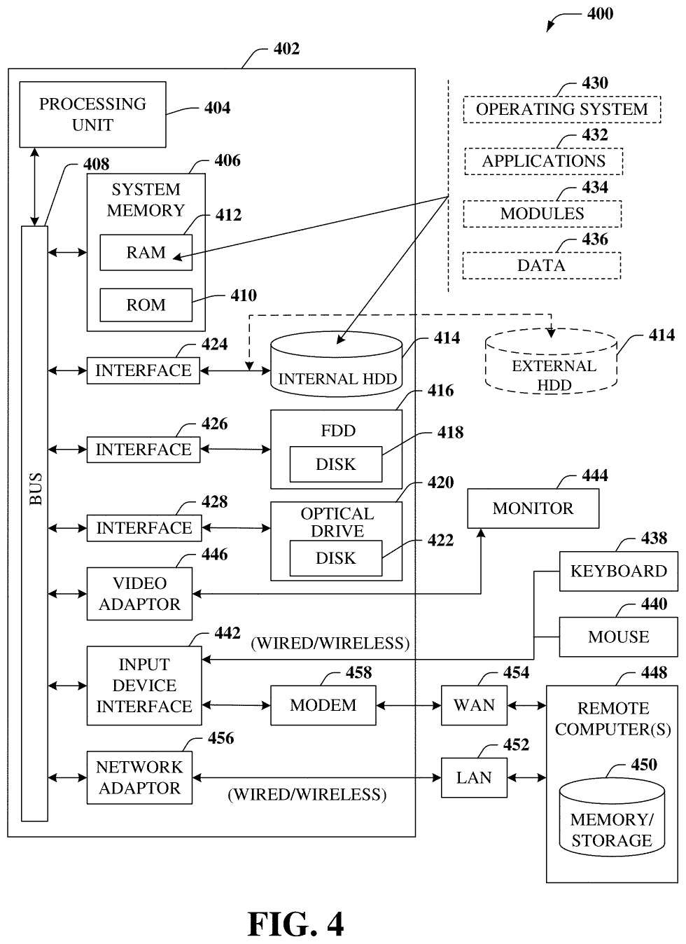

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part receiving information including a total data budget and a target quality level for a video streaming session in which a video program has a plurality of tracks each encoding video content and including a plurality of video content segments for successive presentation; determining a target track for each of the video content segments; providing to a video streaming system the target track for a next successive video content segment; calculating a remaining data budget based on the total data budget and current data usage; and adjusting, in accordance with the remaining data budget, the target track for each remaining video content segment.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

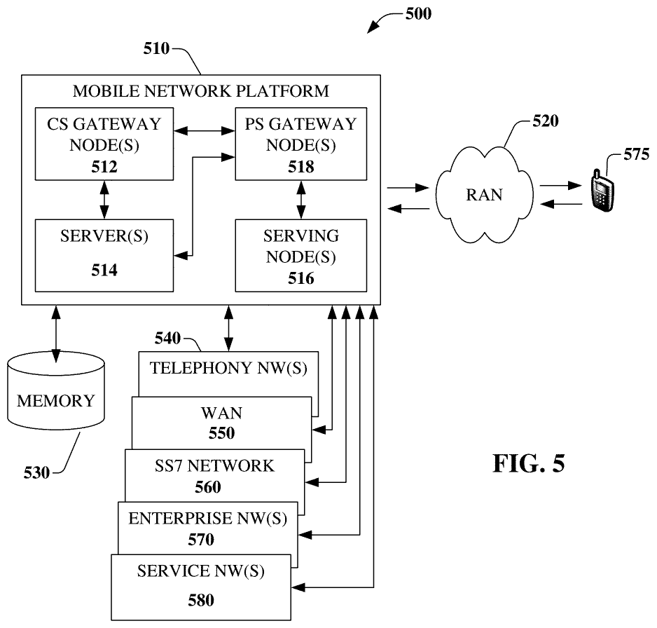

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part receiving information including a total data budget and a target quality level for a video streaming session in which a video program has a plurality of tracks each encoding video content and including a plurality of video content segments for successive presentation; determining a target track for each of the video content segments; providing to a video streaming system the target track for a next successive video content segment; calculating a remaining data budget based on the total data budget and current data usage; and adjusting, in accordance with the remaining data budget, the target track for each remaining video content segment. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 5001, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

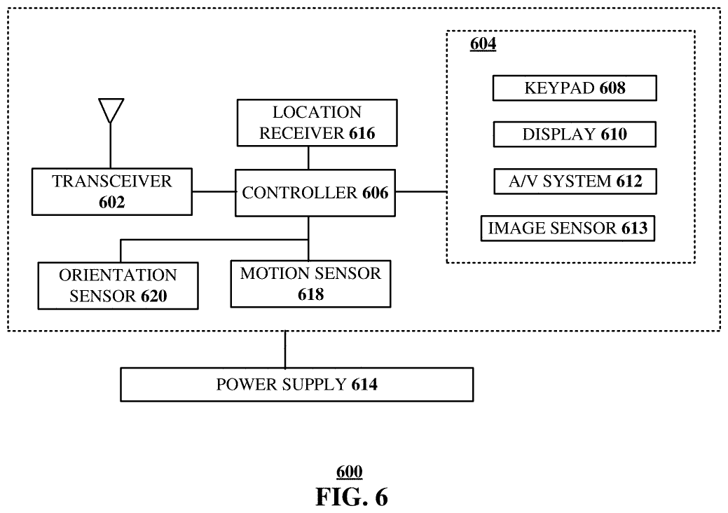

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part receiving information including a total data budget and a target quality level for a video streaming session in which a video program has a plurality of tracks each encoding video content and including a plurality of video content segments for successive presentation; determining a target track for each of the video content segments; providing to a video streaming system the target track for a next successive video content segment; calculating a remaining data budget based on the total data budget and current data usage; and adjusting, in accordance with the remaining data budget, the target track for each remaining video content segment.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, Zigbee®, WiFi, DECT, or cellular communication technologies, just to mention a few (Bluetooth® and the ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method comprising:
receiving, by a processing system including a processor, information comprising a total data budget and a target quality level for a video streaming session in which a video program comprising video content is to be presented, the information received at least in part via user equipment (UE), the video program having a plurality of tracks each encoding the video content, each track comprising a plurality of video content segments for successive presentation;
determining, by the processing system, a mapping of the plurality of tracks to a plurality of quality levels for the video content;
determining, by the processing system, a data budget ladder for the video streaming session based on the mapping and the total data budget;
determining, by the processing system in accordance with the data budget ladder, a target track for each of the plurality of video content segments;
providing, by the processing system, to a video streaming system the target track for a next successive video content segment, wherein the video streaming system selects a track for the video content segment based at least in part on the target track;
estimating, by the processing system, a current data usage for the video streaming session;
calculating, by the processing system, a remaining data budget based on the total data budget and the current data usage; and
adjusting, by the processing system in accordance with the remaining data budget, the target track for each remaining video content segment of the plurality of video content segments.

2. The method of claim 1, further comprising presenting, by the processing system at a display device of the UE, the current data usage, the remaining data budget, or both.

3. The method of claim 2, wherein the video streaming system comprises adaptive bit rate (ABR) logic.

4. The method of claim 1, wherein the information is received in accordance with user input at a user interface of the UE, wherein the user input corresponds to a data usage option selected from one or more data usage options presented at the user interface.

5. The method of claim 4, wherein the UE comprises a smartphone, and wherein the video program is presented at the smartphone.

6. The method of claim 1, wherein the target track for a video content segment of the plurality of video content segments is determined based on a size of the video content segment, the target quality level, the total data budget, or a combination thereof.

7. The method of claim 1, further comprising performing, by the processing system, a track-capping procedure with respect to selection of the track for the video content segment, wherein the track-capping procedure comprises one of a cap-beforehand procedure or a cap-afterward procedure.

8. The method of claim 1, wherein the video streaming system performs downloading, rendering and presentation of the video content segment.

9. The method of claim 1, wherein at a conclusion of the video streaming session, the current data usage does not exceed the total data budget.

10. A device, comprising:
a processing system including a processor; and
a memory that stores executable instructions that, when executed by the processing system, facilitate performance of operations, the operations comprising:
receiving information comprising a total data budget and a target quality level for a video streaming session in which a video program comprising video content is to be presented, wherein the information is received at least in part via user equipment (UE), wherein the video program has a plurality of tracks each encoding the video content, each track comprising a plurality of video content segments for successive presentation;
determining a mapping of the plurality of tracks to a plurality of quality levels for the video content;
determining a data budget ladder for the video streaming session based on the mapping and the total data budget;
determining, in accordance with the data budget ladder, a target track for each of the plurality of video content segments;
providing, to an adaptive bit rate (ABR) video streaming system, the target track for a next successive video content segment, wherein the video streaming system selects a track for the video content segment based at least in part on the target track;
estimating a current data usage for the video streaming session;
calculating a remaining data budget based on the total data budget and the current data usage; and
adjusting, in accordance with the remaining data budget, the target track for each remaining video content segment of the plurality of video content segments.

11. The device of claim 10, wherein the operations further comprise presenting, at a display device of the UE, the current data usage, the remaining data budget, or both.

12. The device of claim 10, wherein the information is received in accordance with user input at a user interface of the UE, wherein the user input corresponds to a data usage option selected from one or more data usage options presented at the user interface.

13. The device of claim 10, wherein the target track for a video content segment of the plurality of video content segments is determined based on a size of the video content segment, the target quality level, the total data budget, or a combination thereof.

14. The device of claim 10, wherein the video streaming system performs downloading, rendering and presentation of the video content segment.

15. The device of claim 10, wherein the operations further comprise performing a track-capping procedure with respect to selection of the track for the video content segment, wherein the track-capping procedure comprises one of a cap-beforehand procedure or a cap-afterward procedure.

16. A non-transitory machine-readable medium comprising executable instructions that, when executed by a processing system including a processor, facilitate performance of operations, the operations comprising:
receiving, via a user interface of a user equipment (UE) device, information comprising a total data budget and a target quality level for a video streaming session in which a video program comprising video content is to be presented, the video program having a plurality of tracks each encoding the video content, each track comprising a plurality of video content segments for successive presentation;
determining a mapping of the plurality of tracks to a plurality of quality levels for the video content;
determining a data budget ladder for the video streaming session based on the mapping and the total data budget;
determining, in accordance with the data budget ladder, a target track for each of the plurality of video content segments;
providing to a video streaming system the target track for a next successive video content segment, wherein the video streaming system comprises adaptive bit rate (ABR) logic, wherein the video streaming system selects a track for the video content segment based at least in part on the target track;
estimating a current data usage for the video streaming session;
calculating a remaining data budget based on the total data budget and the current data usage; and
adjusting, in accordance with the remaining data budget, the target track for each remaining video content segment of the plurality of video content segments.

17. The non-transitory machine-readable medium of claim 16, wherein the operations further comprise presenting, at a display of the UE device, the current data usage, the remaining data budget, or both.

18. The non-transitory machine-readable medium of claim 16, wherein the information is received in accordance with user input at a user interface of the UE device, wherein the user input corresponds to a data usage option selected from one or more data usage options presented at the user interface.

19. The non-transitory machine-readable medium of claim 16, wherein the operations further comprise performing a track-capping procedure with respect to selection of the track for the video content segment, wherein the track-capping procedure comprises one of a cap-beforehand procedure or a cap-afterward procedure.

20. The non-transitory machine-readable medium of claim 16, wherein the target track for a video content segment of the plurality of video content segments is determined based on a size of the video content segment, the target quality level, the total data budget, or a combination thereof.
